(19) United States
(12) Patent Application Publication
(10) Pub. No.: US 2026/0065091 A1
(43) Pub. Date: Mar. 5, 2026

(54) WORK SUPPORT SYSTEM, WORK SUPPORT METHOD, AND INFORMATION STORAGE MEDIUM

(71) Applicant: Cybozu, Inc., Tokyo (JP)

(72) Inventors: Taishi SATO, Tokyo (JP); Yuki NAKAJIMA, Tokyo (JP); Wataru IIJIMA, Kitamoto-shi (JP); Kazutoshi NAKANO, Saitama-shi (JP)

(21) Appl. No.: 19/313,772

(22) Filed: Aug. 28, 2025

(30) Foreign Application Priority Data
Sep. 2, 2024 (JP) 2024-150535

(51) Int. Cl. G06N 5/022

(52) U.S. Cl. CPC G06N 5/022

(57) ABSTRACT

Provided is a work support system including at least one processor configured to: acquire function information relating to a work support function that supports work; cause an artificial intelligence (AI) to generate explanatory information relating to an explanation of the work support function based on the function information; and provide the explanatory information.

### CROSS-REFERENCE TO RELATED APPLICATION

The present disclosure contains subject matter related to that disclosed in Japanese Patent Application JP 2024-150535 filed in the Japan Patent Office on September 2, 2024, the entire contents of which are hereby incorporated by reference.

### BACKGROUND OF THE INVENTION

### 1. Field of the Invention

The present disclosure relates to a work support system, a work support method, and an information storage medium.

### 2. Description of the Related Art

Hitherto, there have been known work support functions that are generated or created to suit work of a user. For example, in Japanese Patent Application Laid-open No. 2024-044150, there is described an application creation support device which holds regular nodes corresponding to data and display programs for each screen that can form a screen flow, and group nodes corresponding to programs that perform a series of processing steps by combining screens, receives a placement operation of a group node for each step of procedural work and a placement operation of a regular node within the group node, and generates a definition file that describes the screen flow in the procedural work.

### SUMMARY OF THE INVENTION

However, in the technology of Japanese Patent Application Laid-open No. 2024-044150, as the number of applications increases, it becomes more difficult to manage the purpose for which each application has been created. For example, as the number of applications increases, it becomes more difficult to manage relationships among the applications. In the technology of Japanese Patent Application Laid-open No. 2024-044150, it is not possible to generate explanatory information relating to an explanation for the application, and hence it is not possible to sufficiently increase convenience of the user. This point is not limited to an application like that of Japanese Patent Application Laid-open No. 2024-044150, and can be said to apply to work support functions in general.

One object of the present disclosure is to increase convenience of a user.

According to at least one aspect of the present disclosure, there is provided a work support system including at least one processor configured to: acquire function information relating to a work support function that supports work; cause an artificial intelligence (AI) to generate explanatory information relating to an explanation of the work support function based on the function information; and provide the explanatory information.

### BRIEF DESCRIPTION OF THE DRAWINGS

FIG. 1 is a diagram for illustrating an example of a hardware configuration of a work support system.

FIG. 2 is a view for illustrating an example of screens displayed on a user terminal.

FIG. 3 is a view for illustrating an example of screens displayed on the user terminal.

FIG. 4 is a view for illustrating an example of screens displayed on the user terminal.

FIG. 5 is a view for illustrating an example of screens displayed on the user terminal.

FIG. 6 is a view for illustrating an example of screens displayed on the user terminal.

FIG. 7 is a diagram for illustrating an example of functions implemented in the work support system.

FIG. 8 is a table for showing an example of a work support database.

FIG. 9 is a diagram for illustrating an example of AI inputs and an AI output when an app is generated.

FIG. 10 is a diagram for illustrating an example of AI inputs and an AI output when explanatory information is generated.

FIG. 11 is a flowchart for illustrating an example of processing executed in the work support system.

FIG. 12 is a flowchart for illustrating the example of processing executed in the work support system.

FIG. 13 is a diagram for illustrating an example of functions implemented in a work support system according to modification examples.

### DESCRIPTION OF THE EMBODIMENTS

### 1. Hardware Configuration

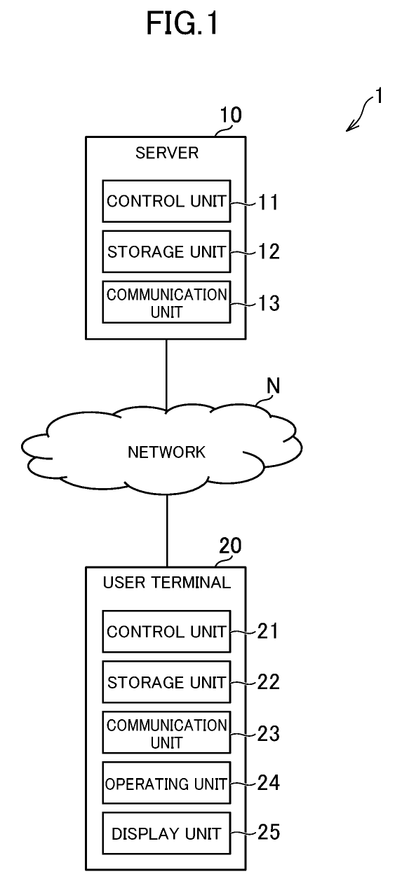

An example of a work support system, a work support method, and a program according to at least one embodiment of the present disclosure is described. FIG. 1 is a diagram for illustrating an example of a hardware configuration of the work support system. For example, a work support system 1 includes a server 10 and a user terminal 20. The server 10 and the user terminal 20 are each connected to a network N such as the Internet or a LAN. One server 10 and one user terminal 20 are illustrated in FIG. 1, but at least one thereof may be provided as two or more components.

The server 10 is a server computer. For example, the server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The user terminal 20 is a computer of a user. For example, the user terminal 20 is a personal computer, a tablet terminal, a smartphone, or a wearable terminal. The user terminal 20 includes a control unit 21, a storage unit 22, a communication unit 23, an operating unit 24, and a display unit 25. Hardware configurations of the control unit 21, the storage unit 22, and the communication unit 23 may be the same as those of the control unit 11, the storage unit 12, and the communication unit 13, respectively. The operating unit 24 includes an input device such as a mouse or a touch panel. The display unit 25 includes a liquid crystal display or an organic EL display.

Programs stored in the storage units 12 and 22 may be supplied via the network N. A hardware configuration of each of the server 10 and the user terminal 20 is not limited to the example of FIG. 1. For example, at least one of the server 10 or the user terminal 20 may include at least one of a reading unit (for example, a memory card slot) that reads a computer-readable information storage medium or an input/output unit (for example, a USB terminal) for directly connecting to an external device. A program stored in the information storage medium may be supplied to at least one of the server 10 or the user terminal 20 through at least one of the reading unit or the input/output unit.

Moreover, the work support system 1 is only required to include at least one computer. The computers included in the work support system 1 are not limited to the example of FIG. 1. For example, the work support system 1 may include only the server 10. In this case, the user terminal 20 is present outside the work support system 1. The work support system 1 may include the server 10 and another computer.

### 2. Overview of Work Support System

In the at least one embodiment, the work support system 1 provides a work support service to users. The work support service is a service that supports work through information processing. The work support service may support work in an organization such as a company or a government agency, or may support work of an individual. A service called groupware is one type of work support service. The work support service may be a cloud-based service or an on-premises service. The work support service may be a service that can support work with no-code or low-code.

For example, the work support system 1 has work support functions relating to support of work. The work support functions are functions implemented by programs developed for work support. The work support functions can also be said to be a collection of programs and data for work support. Types of work support functions may be publicly-known types. For example, the work support functions may be a database function for managing data relating to work in a database, a communication function for communicating with other users, a file management function for managing files, a schedule management function for managing schedules, an email management function for managing emails, or another function.

In the at least one embodiment, a case in which a user belonging to an organization uses the work support service by operating the user terminal 20 to access the server 10 is taken as an example. For example, the user uses the work support function by displaying a website of the work support service on a browser installed in the user terminal 20. The user may use the work support service from a program dedicated to the work support service, instead of from a browser.

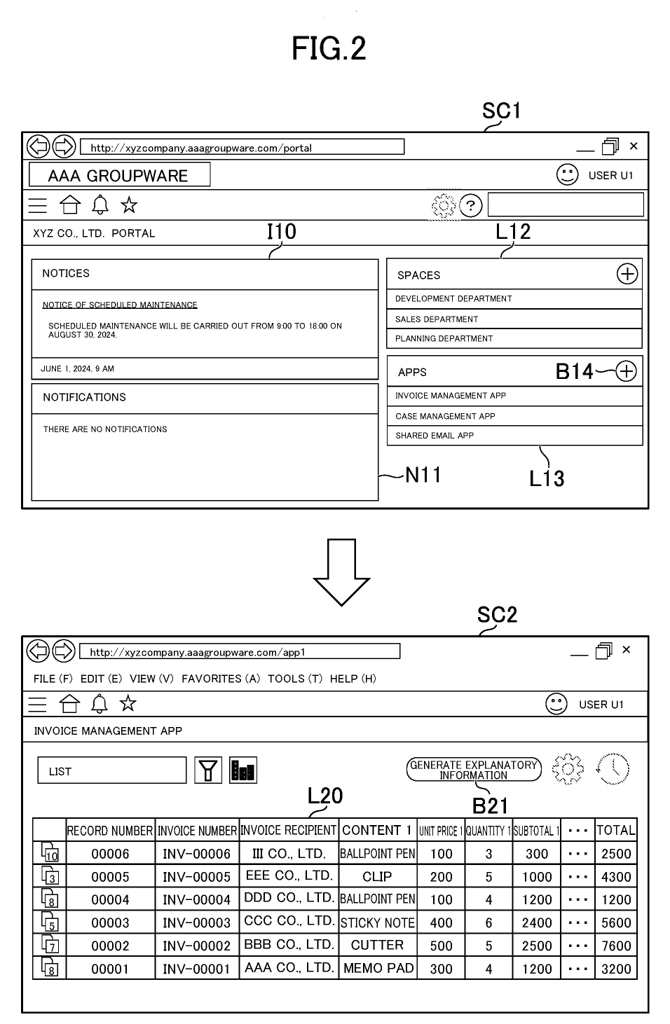

FIG. 2 to FIG. 6 are views for illustrating examples of screens displayed on the user terminal 20. For example, when the user logs in to the work support service, the user terminal 20 displays a portal screen SC1, which corresponds to an entrance to the work support service, on the display unit 25, as in the upper half of FIG. 2. The user can use any of a plurality of work support functions from the portal screen SC1. In the example in the upper half of FIG. 2, the portal screen SC1 displays notices I10 for the user, notifications N11 for the user, a list L12 of spaces in which users can work together, and a list L13 of apps available to the user.

The term "app" is sometimes used as an abbreviation for application, which is a type of program, but in the at least one embodiment, the term "app" is used as an example of a work support function. Thus, the term "app" can be read as "work support function." For example, the app includes a database in which various kinds of data relating to work are stored. The app may a complex work support function that has not only a database function, which is an example of a work support function, but also another work support function as well. For example, the app may have at least one of a communication function for users to communicate with each other or a file management function for managing files as records, which are units of data in the database.

For example, when the user selects an app from the list L13, the user terminal 20 displays, on the display unit 25, an app content screen SC2 showing the content of the app selected by the user, as in the lower half of FIG. 2. In the example in the lower half of FIG. 2, the app content screen SC2 of an invoice management app for managing invoices is shown. The app content screen SC2 displays a list L20 of records, which are units of data registered in the app. The first line of the list L20 displays field names, which are names of fields. A field is also called a column. The second and subsequent lines of the list L20 display the value of each field in each record.

For example, when the user selects a record from the list L20, details of the record selected by the user are displayed on the app content screen SC2. The app content screen SC2 showing the details of the record displays the field names, an input form for receiving input of a value for each field, an input form for receiving input of a comment in the communication function, a comment field showing comments that have already been input, a button for receiving upload of a file in the file management function, or other information. The user can edit an existing record or create a new record from the app content screen SC2 showing the details of the record.

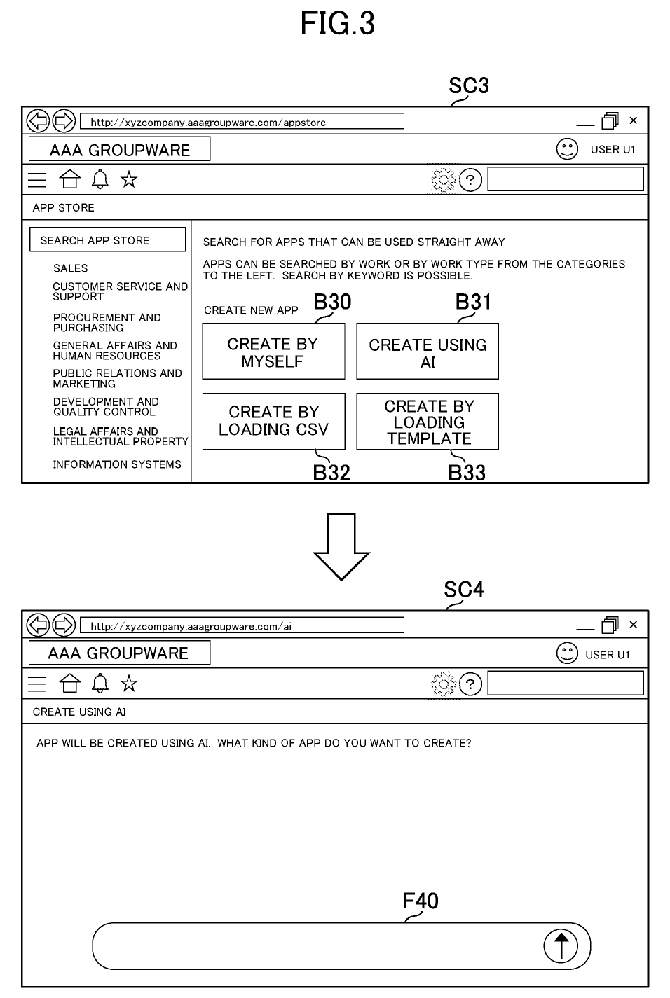

In the at least one embodiment, the user can generate or create a new app to suit the work of the user. For example, when the user selects a button B14 on the portal screen SC1, the user terminal 20 displays, on the display unit 25, an app store screen SC3 which shows an app store that manages apps in the work support service, as in the upper half of FIG. 3. The user can use a sample app prepared as a sample from the app store as the new app as it is, or can generate or create a new app by himself or herself.

For example, when the user selects a button B30, the user can create a new app by designating the setting of the app by himself or herself. When the user selects a button B31, the user can generate a new app by using an artificial intelligence (AI). When the user selects a button B32, the user can create a new app by loading CSV data. When the user selects a button B33, the user can create a new app by loading an app template. The user may also be able to generate or create a new app by another method.

In the at least one embodiment, a case in which the user generates an app by using an AI is taken as an example. The AI is a program having artificial intelligence. There are various views in terms of definitions of the AI, but the AI in the at least one embodiment may be an AI defined by any one of various publicly-known definitions. The AI may be an AI called a generative AI or a conversational AI. Examples of the AI may include a large language model, a machine learning model not classified as a large language model, a program called a bot, or other programs. There are also various views in terms of definitions of machine learning, but the machine learning in the at least one embodiment may be machine learning defined by any one of various publicly-known definitions. The machine learning may be any one of supervised learning, semi-supervised learning, or unsupervised learning.

In the at least one embodiment, a case in which a large language model corresponds to the AI is taken as an example. For example, when the user selects the button B31, the user terminal 20 displays an AI screen SC4 for dialogue with the AI on the display unit 25, as in the lower half of FIG. 3. The user inputs a prompt, which is an instruction to the AI, from an input form F40. The prompt input by the user is hereinafter referred to as "user input prompt." The user can input any content relating to the app that the user wishes as the user input prompt. The user may include other data, such as image data or CSV data, in the user input prompt.

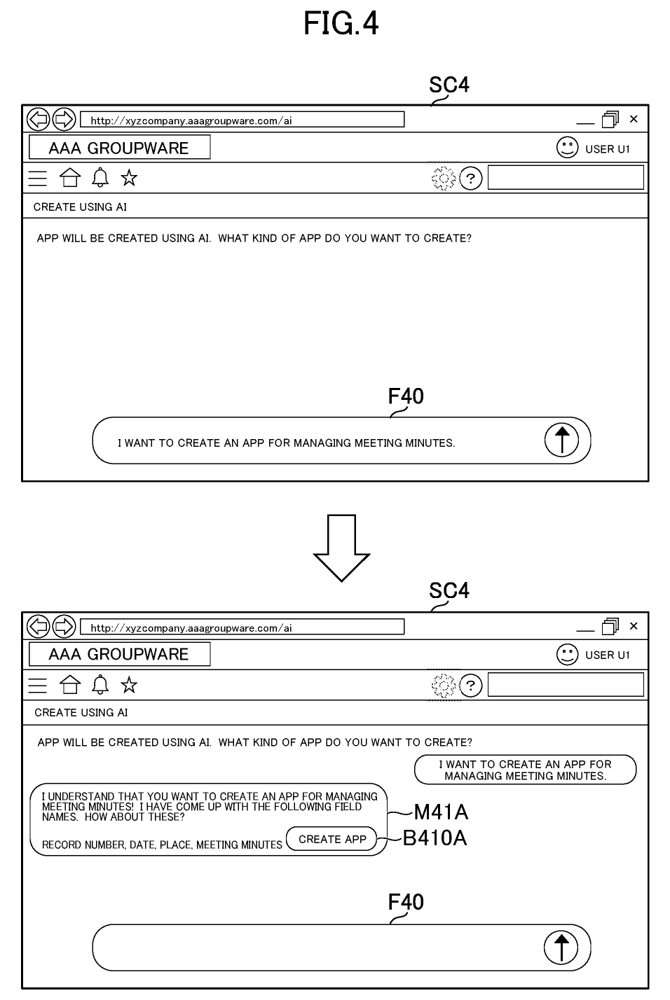

For example, when the user wants to create an app for managing meeting minutes, the user inputs a user input prompt such as "I want to create an app for managing meeting minutes," indicating the content of the app that the user wishes, into the input form F40, as in the upper half of FIG. 4. The user input prompt is transmitted to an external system, which is an external system that manages the AI. The external system inputs the user input prompt to the AI. As described later in detail, another prompt other than the user input prompt may be input to the AI. The AI generates an answer including the app setting corresponding to the user input prompt and a message for the user.

For example, when the AI generates an answer, the user terminal 20 displays a message M41A indicating the answer from the AI on the AI screen SC4, as in the lower half of FIG. 4. In the example in the lower half of FIG. 4, the message M41A indicates the answer from the AI to the user and a field name generated by the AI as the setting of the app. The AI generates a field name corresponding to the wishes of the user indicated by the user input prompt. When the user wants an app for managing meeting minutes, the field name estimated to be appropriate as a field name for an app for managing meeting minutes is displayed in the message M41A.

For example, when the user is satisfied with the content indicated by the message M41A, the user can generate an app with that content by selecting a button B410A. In this case, the app includes a field having the field name indicated by the message M41A. The user may change the app setting generated by the AI. When the user does not like the app setting generated by the AI, the user can instruct the AI to make a correction.

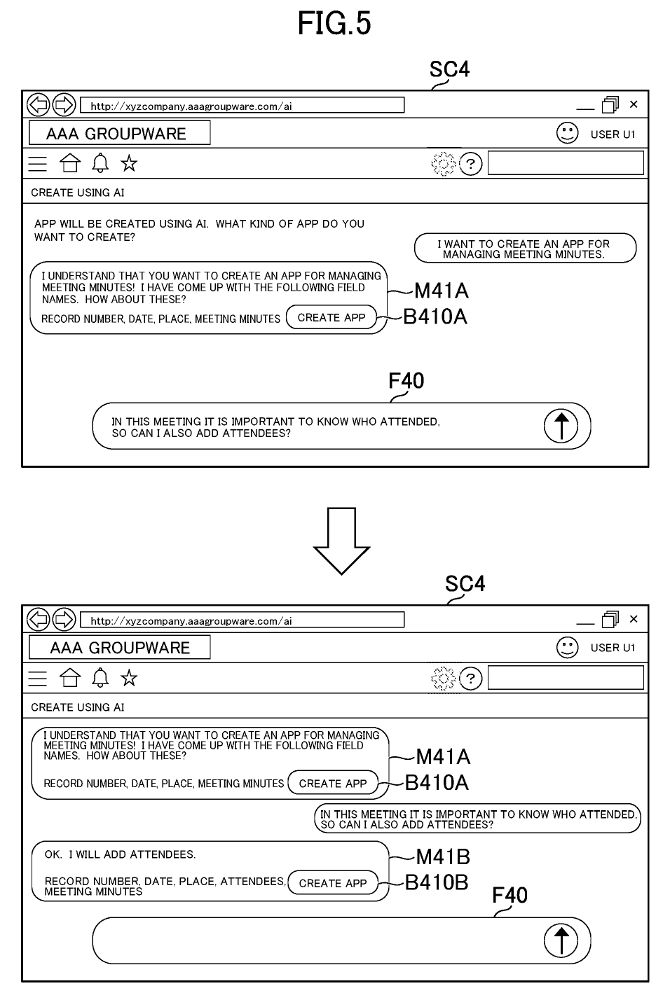

For example, when the user wants to add a field, the user inputs, to the input form F40, a user input prompt such as "In this meeting it is important to know who attended, so can I also add attendees?" indicating the content of the field that the user wants, as in the upper half of FIG. 5. The AI generates an answer corresponding to the user input prompt. The user terminal 20 displays a message M41B indicating that an attendee field has been added on the AI screen SC4, as in the lower half of FIG. 5. The user can repeatedly cause the AI to make a correction until the user is satisfied with the setting generated by the AI. When it is not required to distinguish between the messages M41A and M41B, those messages are simply hereinafter referred to as "message M41." Similarly, when it is not required to distinguish between buttons B410A and B410B, those buttons are simply hereinafter referred to as "button B410."

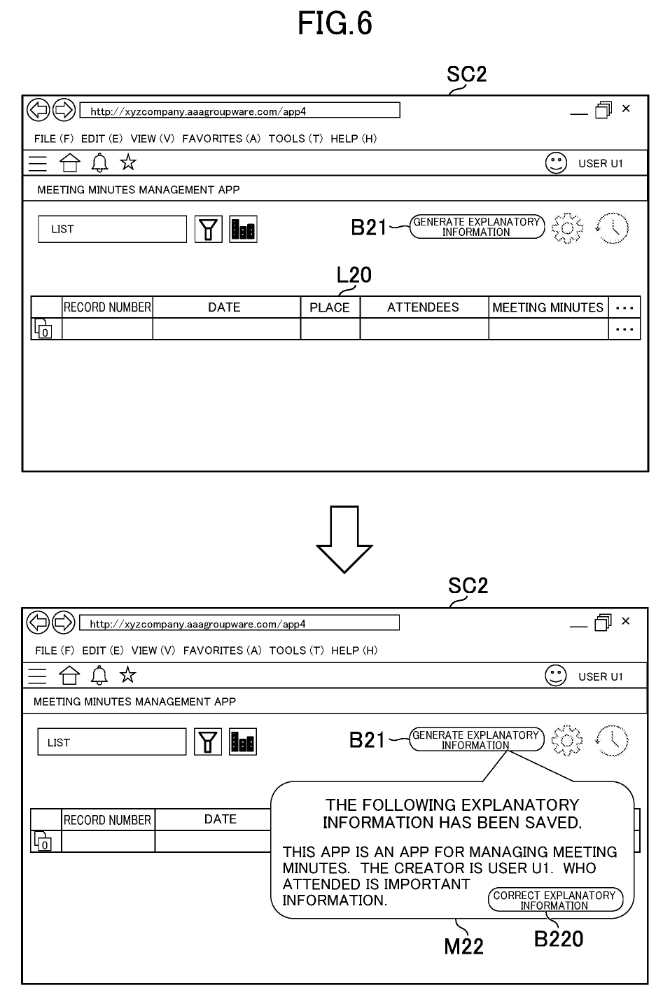

For example, when the user is satisfied with the content indicated by the message M41B, the user can generate an app with that content by selecting the button B410B. When the user selects the button B410B, the server 10 generates a meeting minutes management app for managing meeting minutes based on the setting generated by the AI. When the meeting minutes management app is generated, the meeting minutes management app is added to the list L13 of the portal screen SC1. When the user selects the meeting minutes management app from the list L13, the user terminal 20 displays the app content screen SC2 showing the contents of the meeting minutes management app on the display unit 25, as in the upper half of FIG. 6.

In the example in the upper half of FIG. 6, the field names indicated in the message M41B are displayed in the list L20. The meeting minutes management app may include a field having another name other than the field names indicated in the message M41B. That is, the AI may generate not only the field names indicated in the message M41B, but also field names not indicated in the message M41B. The message M41B may indicate only the field names of representative fields among the field names generated by the AI. The AI may generate not only field names, but also another setting such as an app name. For example, the AI may generate an app name such as "meeting minutes management app" corresponding to the user input prompt.

In the at least one embodiment, the user can cause the AI to generate explanatory information relating to an explanation of the meeting minutes management app. For example, when the user selects a button B21 for generating explanatory information, the AI generates explanatory information based on, for example, the user input prompt input by the user to generate the meeting minutes management app. The user input prompt reflects the intention of the user who has created the meeting minutes management app, and hence the AI generates explanatory information that suits the intention of the user. When the explanatory information is generated, the user terminal 20 displays, on the app content screen SC2, a message M22 indicating that the explanatory information has been generated, as in the lower half of FIG. 6.

For example, the user can correct the explanatory information by selecting a button B220 of the message M22. The explanatory information may be corrected by the AI or manually by the user. The explanatory information is stored in the server 10 in association with the meeting minutes management app. The user can refer to the explanatory information at any time. The explanatory information may be provided to another user other than the user who has created the meeting minutes management app.

In addition, the AI may generate explanatory information for another app other than the meeting minutes management app. For example, the AI may generate explanatory information for an app generated by the user without using the AI. The work support system 1 according to the at least one embodiment is able to prevent, by using the explanatory information for the app, the purpose of an app from becoming unclear even when the number of apps in an organization becomes large or the user who generated or created the app leaves the organization. Details of the work support system 1 are described below.

### 3. Functions Implemented in Work Support System

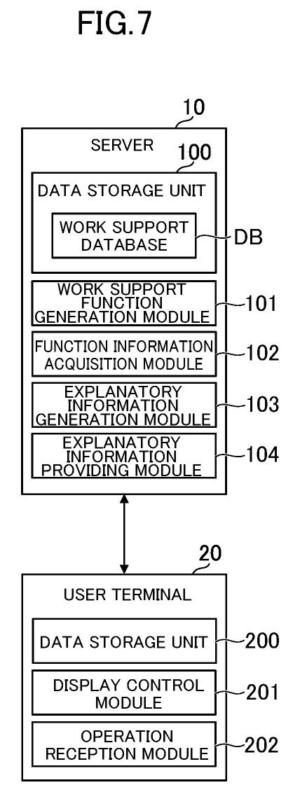

FIG. 7 is a diagram for illustrating an example of functions implemented in the work support system 1.

### 3-1. Functions Implemented in Server

For example, the server 10 includes a data storage unit 100, a work support function generation module 101, a function information acquisition module 102, an explanatory information generation module 103, and an explanatory information providing module 104. The data storage unit 100 is implemented by the storage unit 12. The work support function generation module 101, the function information acquisition module 102, the explanatory information generation module 103, and the explanatory information providing module 104 are implemented by the control unit 11. The function of each of the work support function generation module 101, the function information acquisition module 102, the explanatory information generation module 103, and the explanatory information providing module 104 may be a default function of the work support service, or may be a function added as a plug-in.

### Data Storage Unit

The data storage unit 100 stores various kinds of data in the work support service. For example, the data storage unit 100 stores a work support database DB in which various kinds of data relating to the work support functions are stored. In the at least one embodiment, a case in which the data of each of a plurality of tenants (for example, organizations such as companies) using the work support service is managed in the work support database DB is taken as an example, but the data of each tenant is not required to be managed in a single database called the work support database DB. The storage area of the data storage unit 100 may be divided into an area for each tenant, and the data of each tenant may be managed in the storage area corresponding to the tenant. For example, when a certain tenant adds a plug-in, the data of the plug-in is stored in the storage area corresponding to the tenant.

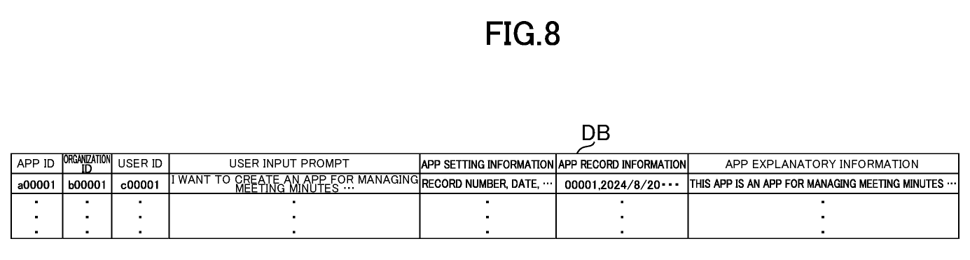

FIG. 8 is a table for showing an example of the work support database DB. In the at least one embodiment, an app is described as an example of the work support function, and hence a case in which various kinds of data relating to the app are stored in the work support database DB is taken as an example. Data relating to another work support function other than the app may be stored in the work support database DB. Separate work support databases DB may be prepared for each of a plurality of work support functions.

For example, the work support database DB stores an app ID that can identify the app, an organization ID that can identify the organization using the app, a user ID that can identify the user who created the app, a user input prompt, setting information on the app, record information that is actual data of a record of the app, and explanatory information. Each time a new app is created, data of the new app is stored in the work support database DB. Each time the explanatory information generation module 103 described later generates explanatory information, the generated explanatory information is stored in the work support database DB.

The data stored in the data storage unit 100 is not limited to the work support database DB. The data storage unit 100 can store any data. For example, the data storage unit 100 may store basic data of a work support function, such as the app as an example. Through applying a setting designated by the user or a setting generated by the AI to basic data, it becomes possible to provide a work support function that is set up to suit the work of the user. The data storage unit 100 may store data (for example, HTML data) required for displaying the portal screen SC1, the app content screen SC2, the app store screen SC3, the AI screen SC4, and the like. The data storage unit 100 may store another prompt input to the AI other than the user input prompt. When another piece of data is input to the AI together with the prompt, the data storage unit 100 may store the another piece of data.

In the at least one embodiment, a case in which the server 10 uses the AI of an external system that cooperates with the work support system 1 is taken as an example, and hence it is assumed that the data storage unit 100 does not store actual data of the AI, but the data storage unit 100 may store the actual data of the AI. That is, in the at least one embodiment, a case in which the actual data of the AI is stored in an external system is taken as an example, but the server 10 may execute various types of processing in the at least one embodiment based on the actual data of the AI which is stored in the data storage unit 100.

For example, the AI includes: a program indicating processing such as calculation of an embedded representation; and parameters to be referred to by the program. The embedded representation is information for the AI to understand the meaning of data. For example, the embedded representation is represented by a multidimensional vector. The embedded representation may also be called a feature amount indicating a feature of data. The embedded representation may be represented in another format other than the multidimensional vector. The AI may include other data (for example, data equivalent to a dictionary of terms) other than the parameters. The other data is referred to by the program. The other data may be data separate from the AI. The AI calculates the embedded representation of input data input to itself based on the parameters, and performs output corresponding to the embedded representation. For example, the parameters are weights and biases.

The program and parameters of the AI may be a publicly-known program and publicly-known parameters, respectively. For example, the program and parameters of the AI may be a program and parameters employed in a large language model, such as a generative pre-trained transformer (GPT) or bidirectional encoder representations from transformers (BERT), a program and parameters employed in a machine learning model, such as a neural network or generative adversarial networks (GAN), a program and parameters employed in a generative AI or a conversational AI that is not classified into those, or another program and other parameters. The program and parameters of the AI may be selected from various programs and parameters that can be understood by a person skilled in the field of computer software based on the common general technical knowledge at the time of filing.

In the at least one embodiment, a large language model (for example, GPT) is described as an example of the AI, and hence the program of the AI indicates processing for analyzing input data (for example, user input prompt) input to the AI. The parameters of the AI are parameters such as weights and biases that are referred to by the AI to analyze the meaning in a natural language. The AI analyzes the input data input to itself based on the parameters adjusted by training, and performs output corresponding to a result of the analysis. For example, the AI divides the text in a natural language indicated by the input data into a plurality of tokens. The AI calculates the embedded representations indicating the meanings of the individual tokens based on the parameters. The AI understands the meaning in a natural language based on a sequential order of the embedded representations of the respective tokens. The AI may make a prediction based on the sequential order of the embedded representations of the respective tokens as required. The AI outputs output data corresponding to the sequential order of the embedded representations.

### Work Support Function Generation Module

The work support function generation module 101 causes the AI (AI that generates explanatory information) or another AI to generate the work support function based on the user input prompt input by the user that relates to the specific content of the work support function. In the at least one embodiment, a case in which the AI that generates the explanatory information and the AI that generates the work support function are the same is taken as an example, but those AIs may be different from each other. The another AI is an AI that is different from the AI that generates the explanatory information. The term "AI" as used in the description of the work support function generation module 101 can be read as "AI or another AI."

The work support function generation module 101 causing the AI to generate the work support function means that the work support function generation module 101 causes the AI to generate data relating to the work support function. For example, the work support function generation module 101 causes the AI to generate the work support function by causing the AI to generate a setting of the work support function. The setting itself of the work support function may be similar to a setting adopted in a publicly-known work support service. The work support function generation module 101 may cause the AI to generate the work support function by causing the AI to generate a program for the work support function. For example, when the work support function is provided to the user by a script executed on a browser, the work support function generation module 101 may cause the AI to generate the work support function by causing the AI to generate the script.

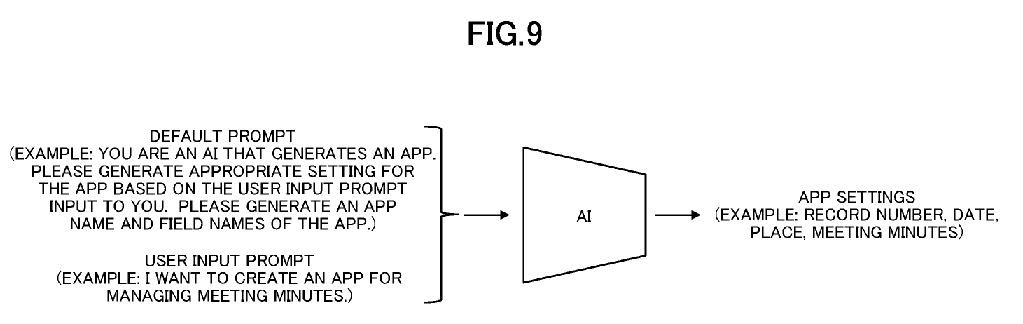

FIG. 9 is a diagram for illustrating an example of AI inputs and an AI output when the app is generated. For example, the work support function generation module 101 inputs a default prompt, which is a prompt prepared in advance, and the user input prompt to the AI. The default prompt is assumed to be stored in the data storage unit 100 in advance. The default prompt may be prepared by an administrator of the work support service, or may be prepared by the user. The default prompt indicates the specific content of the product to be generated by the AI. That is, the default prompt indicates the task to be executed by the AI.

In the at least one embodiment, an app is described as an example of the work support function, and hence the default prompt indicates that a setting of the app is to be generated. For example, the default prompt may indicate a sentence such as "You are an AI that generates an app. Please generate an appropriate setting for the app based on the user input prompt input to you." When there are a plurality of items as the settings of the app, the default prompt may indicate the specific item that the AI is to generate. For example, the default prompt may indicate a sentence such as "Please generate the app name and the field names of the app." The content of the default prompt is not limited to the example of FIG. 9.

The default prompt may indicate another piece of content relating to the setting of the app. For example, the default prompt may include a sentence indicating that the AI is to generate a basic specification of the app (for example, a basic setting item in the app, a help page in the work support service, or a specification document of the app), the number of fields, the types of the fields, the layout in the app content screen SC2, an access rights setting, or another setting. A default prompt may also be prepared for when the user instructs the AI to make a correction. For example, the default prompt during correction may indicate a sentence such as "Please correct the setting of the app you have generated based on the user input prompt."

For example, the work support function generation module 101 inputs the default prompt and the user input prompt to the AI. In the at least one embodiment, the AI is managed by an external system, and hence the work support function generation module 101 inputs the default prompt and the user input prompt to the AI by transmitting the default prompt and the user input prompt to the external system. When the external system receives the default prompt and the user input prompt, the external system inputs the default prompt and the user input prompt to the AI. Additional default prompts may be prepared on the external system side.

For example, the AI calculates an embedded representation of the default prompt and the user input prompt based on parameters adjusted by pre-training. The AI outputs the app setting corresponding to the embedded representation. The AI may divide the default prompt and the user input prompt into units called tokens, and calculate an embedded representation of each token. The AI outputs the setting of the app after predicting the next sentence as required based on a sequence of the embedded representations of the tokens.

In the example of FIG. 9, the AI recognizes that the user wants an app for managing meeting minutes based on the embedded representation of the user input prompt "I want to create an app for managing meeting minutes," and outputs a setting corresponding to the wishes of the user. The AI recognizes the setting that is to be output by the AI based on the embedded representation of the default prompt. The AI may output not only the setting of the app, but also an answer message to the user. The fact that the AI is to output an answer message may be indicated in the default prompt.

For example, the external system transmits the output of the AI to the server 10. The work support function generation module 101 acquires the output of the AI from the external system. The work support function generation module 101 transmits the output of the AI to the user terminal 20. In the at least one embodiment, the setting of the app is generated by the AI, and hence the work support function generation module 101 transmits the setting generated by the AI to the user terminal 20. When the user gives an instruction to make a correction, the work support function generation module 101 inputs the default prompt during correction, and the user input prompt indicating the content of the correction to the AI.

For example, the work support function generation module 101 inputs the default prompt during correction and the user input prompt indicating the content of the correction to the AI by transmitting those prompts to the external system. The external system inputs the default prompt during correction and the user input prompt indicating the content of the correction to the AI. The external system may input, to the AI, the output of the AI up to that point. The AI calculates an embedded representation of the prompt and the like input to the AI, and performs output corresponding to the embedded representation. The processing executed by the AI during correction may be the same as when the initial output is generated. The work support function generation module 101 acquires the content of the correction by the AI from the external system. The work support function generation module 101 transmits the content of the correction by the AI to the user terminal 20. After that, the user may repeatedly give an instruction to make a correction.

For example, when the user gives an instruction to generate an app, the work support function generation module 101 generates the app based on the setting of the app generated by the AI. The work support function generation module 101 issues an app ID and generates the app by storing the organization ID of the organization to which the user belongs, the user ID of the user, the user input prompt, and setting information indicating a setting of the app generated by the AI in an app database. The database in which the organization ID and the user ID are stored is assumed to be stored in advance in the data storage unit 100. The work support function generation module 101 is only required to store the data of the generated app in a storage area corresponding to the organization (an example of a tenant) to which the user belongs, and the storage area may be another storage area other than a storage area in the work support database DB.

In the example of FIG. 9, the AI generates a field name as the setting of the app. The work support function generation module 101 generates the app by applying the field name generated by the AI as a field name of the app to be generated. Similarly, in a case in which the AI generates another setting other than a field name (for example, app name or field type), the work support function generation module 101 may generate the app by applying the another setting generated by the AI as another setting of the app to be generated. The work support function generation module 101 may generate the work support function by causing the AI to generate a setting and recording the generated setting in the data storage unit 100 in the same manner for another work support function other than the app.

### Function Information Acquisition Module

The function information acquisition module 102 acquires function information relating to the work support function that supports work. The function information is information input to the AI when the explanatory information is generated. The function information may be any information that is related to the work support function in some way. For example, the function information may be a setting of the work support function, the data registered in the work support function, a program indicating information processing of the work support function, information in the manual (help guide) of the work support function, a post (for example, a comment) by a user registered in a place such as the work support function or a thread, or other information.

In the at least one embodiment, it is assumed that function information of various kinds of work support functions is stored in the data storage unit 100. For this reason, the function information acquisition module 102 acquires, from the data storage unit 100, the function information of the work support function for which explanatory information is to be generated. The function information may be stored in another computer other than the server 10 or an information storage medium. The function information acquisition module 102 may acquire the function information of the work support function for which explanatory information is to be generated from the another computer or the information storage medium.

In the at least one embodiment, the intention of the user is reflected in the user input prompt input when the user generates the app, and hence the function information acquisition module 102 acquires the user input prompt as the function information. For example, the user input prompt is stored in the work support database DB, and hence the function information acquisition module 102 acquires, from the work support database DB, the user input prompt input by the user to generate the app for which explanatory information is to be generated. For example, when the user selects the button B21 on the app content screen SC2, the function information acquisition module 102 acquires the user input prompt associated with the app ID of the app that is displayed on the app content screen SC2.

In addition, when the user instructs the AI to make a correction, a plurality of user input prompts including the user input prompt initially input by the user and the user input prompt input by the user at the time of correction are stored in the work support database DB, and hence the function information acquisition module 102 may acquire the plurality of user input prompts as the function information. The function information acquisition module 102 may acquire only some of the plurality of user input prompts as the function information. The function information is not limited to the user input prompts, and may be other information. Other examples of the function information are described later in modification examples.

### Explanatory Information Generation Module

The explanatory information generation module 103 causes an artificial intelligence (AI) to generate explanatory information relating to an explanation of the work support function based on the function information. The explanatory information is text showing the explanation of the work support function. The explanatory information may include not only text but also other information such as a diagram or a table. For example, the explanatory information may be an association diagram for showing an association between apps. The explanatory information may explain the purpose, background, objective, data structure, setting details, or other content for which the work support function is generated or created. The explanatory information generation module 103 causes the AI to generate the explanatory information by inputting the function information to the AI.

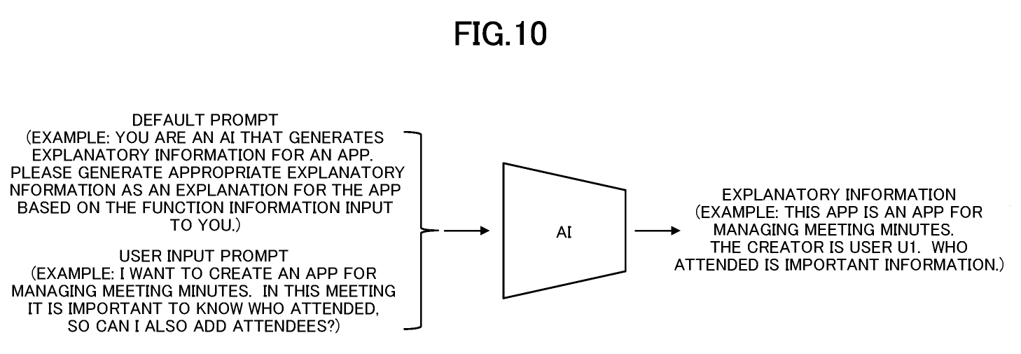

FIG. 10 is a diagram for illustrating an example of AI inputs and an AI output when explanatory information is generated. For example, the explanatory information generation module 103 inputs a default prompt for generating explanatory information and the function information to the AI. The default prompt is assumed to be stored in the data storage unit 100 in advance. The default prompt may be prepared by an administrator of the work support service, or may be prepared by the user. The default prompt indicates that the AI is to generate explanatory information based on the function information. That is, the default prompt indicates that the AI is to generate explanatory information as the task to be executed by the AI.

In the at least one embodiment, an app is described as an example of the work support function, and hence the default prompt indicates that the explanatory information of the app is to be generated. For example, the default prompt may indicate a sentence such as "You are an AI that generates explanatory information for an app. Please generate appropriate explanatory information as an explanation for the app based on the function information input to you." The content of the default prompt is not limited to the example of FIG. 10. The default prompt may indicate a basic specification of the app (for example, a basic setting item in the app, a help page in the work support service, or a specification document of the app), the format or amount of the explanatory information, or other information.

For example, the explanatory information generation module 103 causes the AI to generate the explanatory information based on the user input prompt. The explanatory information generation module 103 inputs the default prompt and the user input prompt to the AI. In the at least one embodiment, the AI is managed by an external system, and hence the explanatory information generation module 103 inputs the default prompt and the user input prompt to the AI by transmitting the default prompt and the user input prompt to the external system. When the external system receives the default prompt and the user input prompt, the external system inputs the default prompt and the user input prompt to the AI. Additional default prompts may be prepared on the external system side.

For example, the AI calculates an embedded representation of the default prompt and the user input prompt based on parameters adjusted by pre-training. The AI outputs the explanatory information of the app corresponding to the embedded representation. The AI may divide the default prompt and the user input prompt into units called tokens, and calculate an embedded representation of each token. The AI outputs the explanatory information of the app after predicting the next sentence as required based on a sequence of the embedded representations of the tokens.

In the example of FIG. 10, the AI recognizes, based on the embedded representations of the user input prompt "I want to create an app for managing meeting minutes" input initially by the user and the user input prompt "In this meeting it is important to know who attended, so can I also add attendees?" input by the user during correction, that the intention of the user is to manage meeting minutes and the content that is important for the app, and outputs explanatory information indicating the recognized intention of the user and the content that is important for the app. The AI recognizes the explanatory information that is to be output by the AI based on the embedded representation of the default prompt. The AI may output not only the explanatory information of the app, but also an answer message to the user. The fact that the AI is to output an answer message may be indicated in the default prompt.

For example, the external system transmits the output of the AI to the server 10. The explanatory information generation module 103 acquires the explanatory information by acquiring the output of the AI from the external system. The explanatory information generation module 103 stores the explanatory information in the work support database DB. In a case in which the user gives an instruction to correct the explanatory information, the explanatory information generation module 103 inputs to the AI the default prompt during correction and the user input prompt indicating the content of the correction to the explanatory information. The explanatory information generation module 103 inputs the default prompt during correction and the user input prompt indicating the content of the correction to the AI by transmitting those prompts to the external system. The external system inputs the default prompt during correction and the user input prompt indicating the content of the correction to the AI. The AI corrects the explanatory information based on those prompts.

In addition, the external system may input, to the AI, the output of the AI up to that point. The AI calculates an embedded representation of the prompt and the like input to the AI, and performs output corresponding to the embedded representation. The processing executed by the AI during correction may be the same as when the initial output is generated. The explanatory information generation module 103 acquires the content of the correction by the AI from the external system. The explanatory information generation module 103 transmits the content of the correction by the AI to the user terminal 20. After that, the user may repeatedly give an instruction to make a correction. In the at least one embodiment, a case in which the explanatory information is generated after the app is generated is taken as an example, but the explanatory information may be generated at the same time as when the app is generated. The processing of the work support function generation module 101 and the processing of the explanatory information generation module 103 may be executed at the same time, instead of being executed separately.

### Explanatory Information Providing Module

The explanatory information providing module 104 provides the explanatory information. The explanatory information providing module 104 providing the explanatory information corresponds to the explanatory information providing module 104 outputting the explanatory information to the user terminal 20. For example, the explanatory information generation module 103 provides the explanatory information by transmitting data of the message M22 indicating the explanatory information to the user terminal 20. The explanatory information providing module 104 can provide the explanatory information on any screen in the work support service. The explanatory information providing module 104 may provide the explanatory information by using other means, such as email or file output.

### 3-2. Functions Implemented in User Terminal

For example, the user terminal 20 includes a data storage unit 200, a display control module 201, and an operation reception module 202. The data storage unit 200 is implemented by the storage unit 22. Each of the display control module 201 and the operation reception module 202 is implemented by the control unit 21.

### Data Storage Unit

The data storage unit 200 stores data for a user to use the work support service. For example, the data storage unit 200 stores a browser for displaying various screens of the work support system 1. For example, the data storage unit 200 stores an application dedicated to the work support system 1.

### Display Control Module

The display control module 201 displays various screens in the work support system 1 on the display unit 25. For example, the display control module 201 displays, on the display unit 25, the portal screen SC1, the app content screen SC2, the app store screen SC3, and the AI screen SC4 based on data received from the server 10.

### Operation Reception Module

The operation reception module 202 receives various operations in the work support system 1. For example, the operation reception module 202 receives operations on the portal screen SC1, the app content screen SC2, the app store screen SC3, and the AI screen SC4. Data indicating the operation content received by the operation reception module 202 is transmitted to the server 10 as appropriate.

### 4. Processing Executed in Work Support System

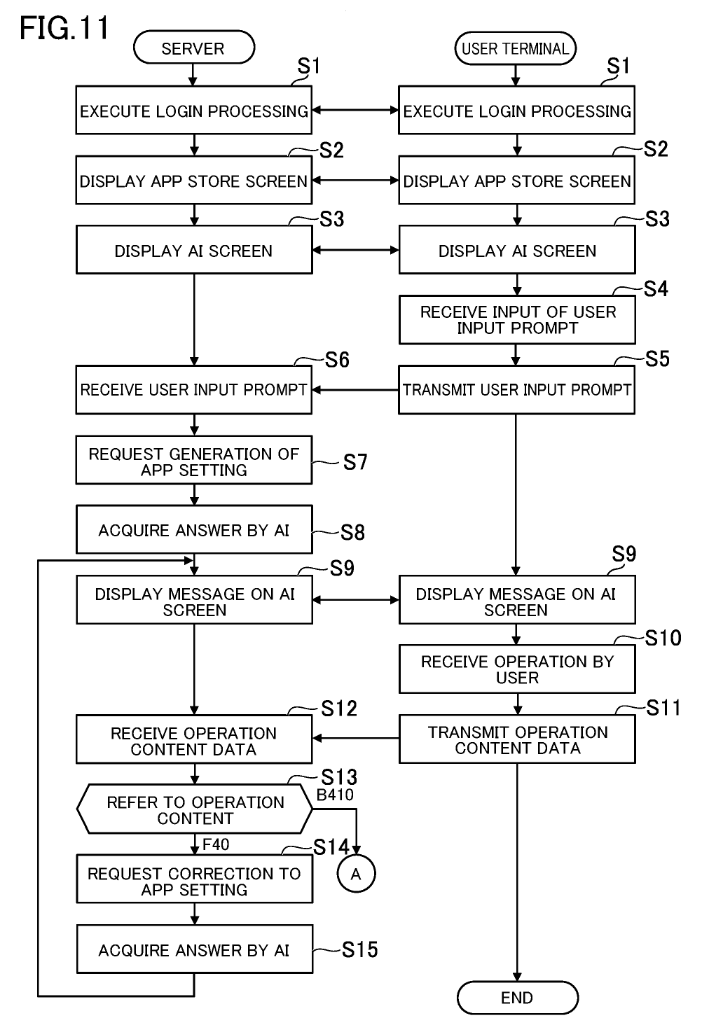

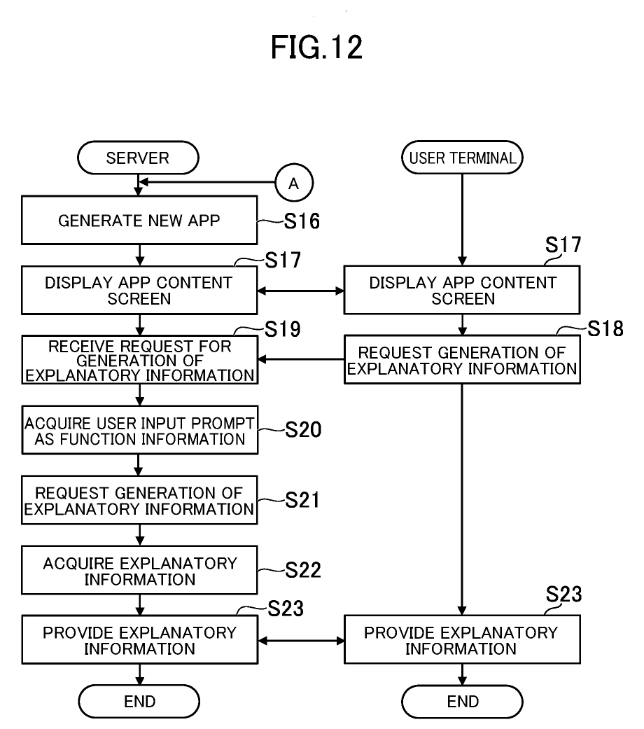

FIG. 11 and FIG. 12 are flowcharts for illustrating an example of processing executed in the work support system 1. Processing steps of FIG. 11 and FIG. 12 are executed by the control units 11 and 21 executing the programs stored in the storage units 12 and 22, respectively. Respective processing steps of FIG. 11 and FIG. 12 are examples of processing steps included in the work support method.

As illustrated in FIG. 11, the user terminal 20 executes, between the user terminal 20 and the server 10, login processing for the user to log in to the work support service (Step S1). When the user selects the button B14, the user terminal 20 executes, between the user terminal 20 and the server 10, processing for displaying the app store screen SC3 (Step S2). When the user selects the button B31, the user terminal 20 executes, between the user terminal 20 and the server 10, processing for displaying the AI screen SC4 (Step S3).

The user terminal 20 receives input of the user input prompt to the input form F40 (Step S4). The user terminal 20 transmits the user input prompt to the server 10 (Step S5). The server 10 receives the user input prompt from the user terminal 20 (Step S6). The server 10 requests the external system to generate the setting of the app based on the user input prompt received in Step S6 (Step S7). The server 10 acquires the answer by the AI from the external system (Step S8).

The server 10 executes, between the server 10 and the user terminal 20, processing for displaying the message M41 on the AI screen SC4 (Step S9). The user terminal 20 receives an operation by the user (Step S10). In Step S10, input of the user input prompt to the input form F40 or selection of the button B410 is received. The user terminal 20 transmits operation content data indicating the content of the operation by the user to the server 10 (Step S11). The server 10 receives the operation content data from the user terminal 20 (Step S12).

The server 10 refers to the operation content indicated by the operation contents data (Step S13). In Step S13, when the user input prompt for correction is input (Step S13: F40), the server 10 requests the external system to correct the setting of the app based on the user input prompt (Step S14). The server 10 acquires an answer by the AI from the external system (Step S15), and the process returns to Step S9. After that, a correction instruction by the user is repeated until the button B410 is selected in Step S13.

In Step S13, when the button B410 is selected (Step S13: B410), the process advances to FIG. 12, and the server 10 executes processing for generating a new app based on the setting of the app generated by the AI (Step S16). When the user selects a new app, the server 10 executes, between the server 10 and the user terminal 20, processing for displaying the app content screen SC2 showing the content of the new app (Step S17). When the user selects the button B21, the user terminal 20 requests the server 10 to generate explanatory information (Step S18). The server 10 receives the request to generate explanatory information from the user terminal 20 (Step S19).

The server 10 acquires, as the function information, a user input prompt which is input by the user during generation of the app based on the work support database DB (Step S20). The server 10 requests the external system to generate explanatory information by the AI based on the function information (Step S21). The server 10 acquires the explanatory information generated by the AI from the external system (Step S22). The server 10 executes, between the server 10 and the user terminal 20, processing for providing the explanatory information to the user terminal 20 (Step S23), and the process ends. In Step S23, the message M22 is displayed. When the user has given an instruction to correct the explanatory information, the explanatory information is corrected based on a user input prompt indicating the content of the correction.

### 5. Summary of at Least One Embodiment

The work support system 1 according to the at least one embodiment acquires function information relating to a work support function. The work support system 1 causes the AI to generate explanatory information relating to an explanation of the work support function based on the function information. The work support system 1 provides the explanatory information. As a result, even when the number of apps in an organization becomes large or the user who created the app leaves the organization, the user can know why the app has been created based on the explanatory information, and hence the work support system 1 can increase the convenience of the user. For example, the user can manage apps more easily based on the explanatory information.

Further, the work support system 1 causes the AI or another AI to generate a work support function based on a user input prompt. The work support system 1 acquires the user input prompt as the function information. The work support system 1 causes the AI to generate the explanatory information based on the user input prompt. As a result, the work support system 1 can cause the AI to generate explanatory information based on a user input prompt that directly reflects the intention of the user who has generated the work support function, such as the app as an example, and hence can increase the accuracy of the explanatory information.

### 6. Modification Examples

The present disclosure is not limited to the at least one embodiment described above. The present disclosure can be modified as required without departing from the purport of the present disclosure.

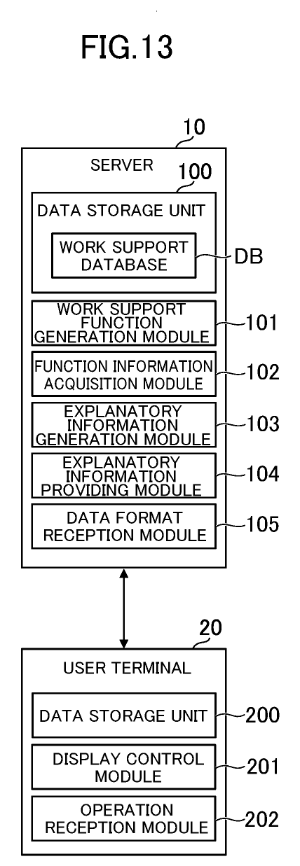

FIG. 13 is a diagram for illustrating an example of functions implemented in the work support system 1 according to the modification examples. As illustrated in FIG. 13, in the modification examples described below, the server 10 includes a data format reception module 105. The data format reception module 105 is implemented by the control unit 11.

### 6-1. Modification Example 1

For example, in the at least one embodiment, the user input prompt has been described as an example of the function information. The function information may be any information relating to the work support function for which the explanatory information is generated, and is not limited to a user input prompt. In Modification Examples 1 to 6, description is given of other examples of the function information. The function information is a concept that includes the examples described in the at least one embodiment and Modification Examples 1 to 6. In the modification examples, the app for which explanatory information is to be generated is not required to be an app generated by the AI, and may be an app in which a setting is designated by the user (an app created by a user). Examples of the function information described in the at least one embodiment and Modification Examples 1 to 6 may be combined. For example, two or more pieces of the function information among the function information of the at least one embodiment and Modification Examples 1 to 6 may be input to the AI.

The function information acquisition module 102 in Modification Example 1 acquires setting information relating to a setting of the work support function as the function information. The setting of the work support function may be any one of various settings adopted in a publicly-known work support service. The setting of the work support function may be the specific content of the information processing of the work support function, a layout of the screens of the work support function, an access right to the data of the work support function, or another setting. When the AI is a large language model, it is assumed that the setting information is represented in text in a natural language so that the AI can recognize the setting information. When the AI can recognize information other than text (for example, images), the setting information may be information other than text.

In Modification Example 1, a case in which an app corresponds to the work support function is taken as an example, as in the at least one embodiment. For example, the setting information of the app may be an app name, a memo for explaining the app, a display format of the list L20 in the app content screen SC2, a layout of an input form in the app content screen SC2, a display format of a graph in the app content screen SC2, a design of the app content screen SC2, a field name, a field type (data type of the field), an expression (function) set in the field, a notification setting for a user, an access right, a language, or another setting. The function information acquisition module 102 may acquire setting information indicating all or some of the settings of the app. In other words, the setting information is not required to indicate all of the settings of the app.

In Modification Example 1, a case in which the setting information of the app is stored in the work support database DB is taken as an example, as in the at least one embodiment. The function information acquisition module 102 acquires, from the work support database DB, the setting information of the app for which explanatory information is to be generated. The setting information of the app may be stored in another database other than the work support database DB, another computer other than the server 10, or an information storage medium. In this case, the function information acquisition module 102 may acquire the setting information of the app for which explanatory information is to be generated from the another database, the another computer other than the server 10, or the information storage medium.

In addition, the function information acquisition module 102 may acquire the setting information of another app related to the app for which explanatory information is to be generated. The another app is another app having a record which is referred to by the app for which explanatory information is to be generated, or another app which refers to a record of the app for which explanatory information is to be generated. The reference to the record may be identified by an expression such as a lookup. The function information acquisition module 102 may identify the relationship between the apps from information on the expression set in the app, and acquire the setting information of the another app related to the app for which explanatory information is to be generated.

Further, when explanatory information on another work support function other than the app is to be generated, the function information acquisition module 102 may acquire setting information on the another work support function. The setting information acquired by the function information acquisition module 102 is not limited to the example described above. For example, when explanatory information of a communication function is to be generated, the function information acquisition module 102 may acquire setting information indicating the name of the place from which a post is made in the communication function (for example, a thread name), information on users who can use the communication function, a design of the screens in the communication function, or another setting.

For example, when explanatory information for a file management function is to be generated, the function information acquisition module 102 may acquire setting information indicating the type of files that can be managed by the file management function, the data size of the files, the number of files, the name of the file management function, information on users who can use the file management function, a design of the screens in the file management function, or another setting. When explanatory information for a schedule management function is to be generated, the function information acquisition module 102 may acquire setting information indicating a registration rule of the schedule in the schedule management function, the name of the schedule management function, information on users who can use the schedule management function, a design of the screens in the schedule management function, or another setting.

The explanatory information generation module 103 in Modification Example 1 causes the AI to generate the explanatory information based on the setting information. For example, the explanatory information generation module 103 inputs a default prompt and the setting information to the AI. The default prompt in Modification Example 1 indicates that the AI is to generate explanatory information based on the setting indicated by the setting information. For example, the default prompt indicates a sentence such as "You are an AI that generates explanatory information for an app. Please generate appropriate explanatory information as an explanation for the app based on the setting indicated by the setting information input to you."

For example, in Modification Example 1, the AI is managed by an external system, and hence the explanatory information generation module 103 inputs the default prompt and the setting information to the AI by transmitting the default prompt and the setting information to the external system. When the external system receives the default prompt and the setting information, the external system inputs the default prompt and the setting information to the AI. Additional default prompts may be prepared on the external system side.

For example, the AI calculates an embedded representation of the default prompt and the setting information based on parameters adjusted by pre-training. The AI outputs the app explanatory information corresponding to the embedded representation. The AI may divide the default prompt and the setting information into units called tokens, and calculate an embedded representation of each token. The AI outputs the explanatory information of the app after predicting the next sentence as required based on a sequence of the embedded representations of the tokens.

For example, the setting information may indicate the field name of the app. The AI recognizes the purpose of the app, that is, managing meeting minutes, based on the embedded representation of each field name in the app, and outputs explanatory information corresponding to the purpose of the app. The AI recognizes the explanatory information that is to be output by the AI based on the embedded representation of the default prompt. The AI may output not only the explanatory information of the app, but also an answer message to the user. The fact that the AI is to output an answer message may be indicated in the default prompt.

The flow in which the explanatory information generation module 103 acquires the output of the AI from the external system and the explanatory information providing module 104 provides the explanatory information may be the same as in the at least one embodiment. Further, the AI may be able to recognize that explanatory information is to be generated even when only setting information has been input, and hence the explanatory information generation module 103 may input only the setting information to the AI without particularly inputting a default prompt to the AI. Further, when the AI is not a general-purpose large language model but an AI specialized in generating explanatory information (for example, an AI that has learned explanatory information for training), the AI can identify the task the AI is to perform, that is, generating explanatory information, even when a default prompt has not been input. Thus, a default prompt is not particularly required to be input to the AI.

The work support system 1 according to Modification Example 1 acquires the setting information relating to the setting of the work support function as the function information. The work support system 1 causes the AI to generate explanatory information based on the setting information. The setting information of the work support function may indicate the purpose of the work support function, and hence the work support system 1 can increase the accuracy of the explanatory information by causing the AI to generate the explanatory information based on setting information indicating the purpose of the work support function.

### 6-2. Modification Example 2

For example, as the setting information, the user may be able to set a program code for extending the work support function. In Modification Example 2, a case in which a script executed on a browser corresponds to the program code is taken as an example, but the program code may be a code generated or created in any programming language. The program code may be manually created by the user or may be generated by the AI. It can be said that the program code for extending the work support function is another program code other than the program code indicated by a default program prepared by the work support service.

For example, in the work support service, the default program of the work support function is prepared in advance so that the user can use the work support function with no-code or low-code. When the user wants to extend the work support function in addition to the default program, the user generates or creates a program code for function extension. For example, the user generates or creates a program code for highlighting and displaying a specific record on the app content screen SC2, a program code for data aggregation, a program code for executing another calculation other than that of the expression prepared in the work support service, or a program code for other processing.

The function information acquisition module 102 in Modification Example 2 acquires the program code for extending the work support function as the setting information. For example, when the user inputs a program code for extending the work support function of a certain app, the program code is stored in the work support database DB in association with the app ID of the app. The function information acquisition module 102 acquires the program code of the app for which explanatory information is to be generated from the work support database DB as the setting information. As in Modification Example 1, the function information acquisition module 102 may acquire the program code of another app related to the app for which explanatory information is to be generated, and may acquire the program code of the app from another database, another computer, or an information storage medium.

The explanatory information generation module 103 in Modification Example 2 causes the AI to generate explanatory information based on the program code. For example, the explanatory information generation module 103 inputs the default prompt and the program code, which is an example of the setting information, to the AI. The AI calculates an embedded representation of the default prompt and the program code based on parameters adjusted by pre-training. The AI outputs the app explanatory information corresponding to the embedded representation. The AI may divide the default prompt and the program code into units called tokens, and calculate an embedded representation of each token. The AI outputs the explanatory information of the app after predicting the next sentence as required based on a sequence of the embedded representations of the tokens.

The flow in which the explanatory information generation module 103 acquires the output of the AI from the external system and the explanatory information providing module 104 provides the explanatory information may be the same as in Modification Example 1. The point that a default prompt is not particularly required to be input to the AI may also be the same as in Modification Example 1.

The work support system 1 according to Modification Example 2 acquires the program code for extending the work support function as the setting information. The work support system 1 causes the AI to generate explanatory information based on the program code. The program code generated in order to extend the work support function may express the purpose of the work support function more clearly, and hence the work support system 1 can increase the accuracy of the explanatory information by causing the AI to generate the explanatory information based on a program code that expresses the purpose of the work support function more clearly.

### 6-3. Modification Example 3

For example, as described in the at least one embodiment, the work support function may be a database function that supports work by using a database. In Modification Example 3, as in the at least one embodiment, an app is described as an example of the database function, but the database function may be a work support function that is not called an app. For example, the database function is not particularly required to be a complex work support function such as a communication function, and may be a function for providing spreadsheet software to a user on the cloud.

The function information acquisition module 102 in Modification Example 3 acquires record information relating to a record in a database as the function information. The record information is information indicating the specific content of the record. For example, the record information may be the specific value of each field in the record, a comment registered in the record, a reaction to the comment, a file uploaded to the record, or other content.

For example, the function information acquisition module 102 may acquire the record information of all the records in the app, or may acquire the record information of some of the records in the app. In Modification Example 3, a case in which the function information acquisition module 102 acquires the record information of any of a plurality of records in the app is taken as an example. Each piece of record information may indicate the value of only some of the fields, and not the values of all the fields.

In Modification Example 3, as in the at least one embodiment, a case in which the record information is stored in the work support database DB is taken as an example. The function information acquisition module 102 acquires the record information of the app for which explanatory information is to be generated from the work support database DB. The record information may be stored in another database other than the work support database DB, another computer other than the server 10, or an information storage medium. In this case, the function information acquisition module 102 may acquire the record information of the app for which explanatory information is to be generated from the another database, the another computer other than the server 10, or the information storage medium. Further, as in Modification Example 1, the function information acquisition module 102 may acquire the record information of another app related to the app for which explanatory information is to be generated.

The explanatory information generation module 103 in Modification Example 3 causes the AI to generate the explanatory information based on the record information. For example, the explanatory information generation module 103 inputs a default prompt and the record information to the AI. The default prompt in Modification Example 3 indicates that the AI is to generate explanatory information based on the content of the record indicated by the record information. For example, the default prompt indicates a sentence such as "You are an AI that generates explanatory information for an app. Please generate appropriate explanatory information as an explanation for the app based on the content of the record indicated by the record information input to you."

For example, in Modification Example 3, the AI is managed by an external system, and hence the explanatory information generation module 103 inputs the default prompt and the record information to the AI by transmitting the default prompt and the record information to the external system. When the external system receives the default prompt and the record information, the external system inputs the default prompt and the record information to the AI. Additional default prompts may be prepared on the external system side.

For example, the AI calculates an embedded representation of the default prompt and the record information based on parameters adjusted by pre-training. The AI outputs the app explanatory information corresponding to the embedded representation. The AI may divide the default prompt and the record information into units called tokens, and calculate an embedded representation of each token. The AI outputs the explanatory information of the app after predicting the next sentence as required based on a sequence of the embedded representations of the tokens.

For example, the record information may indicate the value of each field in the record. The AI recognizes the purpose of the app, that is, managing meeting minutes, based on the embedded representation of the value of each field, and outputs explanatory information corresponding to the purpose of the app. The flow in which the explanatory information generation module 103 acquires the output of the AI from the external system and the explanatory information providing module 104 provides the explanatory information may be the same as in the at least one embodiment and Modification Examples 1 and 2. The point that a default prompt is not particularly required to be input to the AI may also be the same as in Modification Examples 1 and 2.

In Modification Example 3, the work support function is a database function that supports work by using a database. The work support system 1 acquires record information relating to a record in the database as the function information. The work support system 1 causes the AI to generate explanatory information based on the record information. The record information of the database function may contain the specific content of the data managed by the database function, and hence the work support system 1 can increase the accuracy of the explanatory information by causing the AI to generate the explanatory information based on the record information in which the specific data content is contained.

The function information acquisition module 102 may acquire a plurality of pieces of record information each corresponding to one of a plurality of records. The explanatory information generation module 103 may cause the AI to generate the explanatory information based on the plurality of pieces of record information arranged in accordance with the order of the plurality of records in the database. For example, the order of the records is identified by a record number assigned to each record such that the records are sequential. The order of the records may be identified by using information that can identify each record in a publicly-known database. For example, when information called an index or a line number is assigned to each record, the order of the records may be identified by the index or line number. The explanatory information generation module 103 sorts the record information of each of the plurality of records in ascending or descending order, and inputs the sorted record information to the AI.

For example, the explanatory information generation module 103 sorts each of the plurality of pieces of record information in the same order as the order of the records in the app, and inputs the sorted record information to the AI. The AI calculates the embedded representation of each of the plurality of pieces of record information, and generates explanatory information based on the order of the embedded representations. That is, the AI may recognize the order of the plurality of pieces of record information as a context, and generate explanatory information corresponding to the order of each of the plurality of pieces of record information. The AI generates the explanatory information by recognizing the order of each of the plurality of pieces of record information as a context, and hence the work support system 1 can increase the accuracy of the explanatory information by causing the AI to generate the explanatory information corresponding to the order of each of the plurality of pieces of record information.

### 6-4. Modification Example 4

For example, information on who has generated or created a work support function may be useful as an explanation of the work support function. When a user in charge of taking meeting minutes has generated or created a work support function, that work support function may relate to meeting minutes. When a user in charge of accounting has generated or created a work support function, that work support function may relate to accounting. When a user in charge of legal affairs has generated or created a work support function, that work support function may relate to legal affairs. For this reason, user information relating to the user may be used as the function information.

The function information acquisition module 102 in Modification Example 4 acquires user information relating to the user who has generated or created the work support function (for example, user who has caused the AI to generate the app, or user who has created the app by himself or herself) as the function information. The user information may be any information relating to the user. The user information may be information relating to an attribute of the user. For example, the user information may be the number of times the user has created an app, a user name, work content that the user is responsible for, the organization to which the user belongs, a group (for example, a team or department) in the organization, profile information, the year of joining the organization, the number of years of service, a job title, a career history, or other information.

The data storage unit 100 in Modification Example 4 stores a user database in which the user information is stored. For example, in the user database, the user information is associated with a user ID (for example, a login account) that can identify the user. The function information acquisition module 102 acquires the user information associated with the user ID of the user who has generated or created the work support function from the user database. The user information may be stored in another database other than the user database, another computer other than the server 10, or an information storage medium. In this case, the function information acquisition module 102 may acquire the user information from the another database, the another computer other than the server 10, or the information storage medium. In addition, the user ID may be used as the user information.

The explanatory information generation module 103 in Modification Example 4 causes the AI to generate explanatory information based on the user information. The default prompt in Modification Example 4 indicates that the AI is to generate explanatory information based on the setting indicated by the user information. For example, the default prompt indicates a sentence such as "You are an AI that generates explanatory information for an app. The user information input to you is information on the user who has generated or created the app. Please generate appropriate explanatory information as an explanation for the app based on the user information."

For example, in Modification Example 4, the AI is managed by an external system, and hence the explanatory information generation module 103 inputs the default prompt and the user information to the AI by transmitting the default prompt and the user information to the external system. When the external system receives the default prompt and the user information, the external system inputs the default prompt and the user information to the AI. Additional default prompts may be prepared on the external system side.

For example, the AI calculates an embedded representation of the default prompt and the user information based on parameters adjusted by pre-training. The AI outputs the app explanatory information corresponding to the embedded representation. The AI may divide the default prompt and the user information into units called tokens, and calculate an embedded representation of each token. The AI outputs the explanatory information of the app after predicting the next sentence as required based on a sequence of the embedded representations of the tokens.

For example, the user information may indicate work content the user is responsible for. The AI recognizes the purpose of the app from the work of the user, that is, meeting minutes, based on the work content the user is responsible for, and outputs explanatory information corresponding to the purpose of the app. The AI recognizes the explanatory information that is to be output by the AI based on the embedded representation of the default prompt. The AI may output not only the explanatory information of the app, but also an answer message to the user. The fact that the AI is to output an answer message may be indicated in the default prompt. The flow in which the explanatory information generation module 103 acquires the output of the AI from the external system and the explanatory information providing module 104 provides the explanatory information may be the same as in the at least one embodiment and Modification Examples 1 to 3. The point that a default prompt is not particularly required to be input to the AI may also be the same as in Modification Examples 1 to 3.

The work support system 1 according to Modification Example 4 acquires the user information relating to the user who has generated or created the work support function as the function information. The work support system 1 causes the AI to generate the explanatory information based on the user information. Information on who has generated or created the work support function may be useful as the explanation of the work support function, and hence the work support system 1 can increase the accuracy of the explanatory information by causing the AI to generate the explanatory information based on the user information.

### 6-5. Modification Example 5

For example, a link to another work support function may be associated with the work support function. When an app corresponds to the work support function, and a link to another app is attached to a comment of a certain app, those apps may have a relevance to each other. The relevance of an app may be useful as an explanation for the app. Thus, in Modification Example 5, a case in which a link is acquired as the function information is taken as an example.

The function information acquisition module 102 in Modification Example 5 acquires link information relating to a link to another work support function that is associated with the work support function as the function information. The link information indicates a link for accessing a specific screen of the another work support function (for example, the app content screen SC2 showing a specific record of another app). For example, the link information may indicate a URL of the another work support function, or may be information other than a URL. The link information may be included as actual data of the work support function.

For example, when an app corresponds to the work support function, the function information acquisition module 102 acquires link information indicating a link attached to a comment of the app. The link information may be included as a value of a field, and not as a comment of the app. In this case, the function information acquisition module 102 may acquire the link information by referring to the value of the field. The link information may be stored in another database other than the work support database DB, another computer other than the server 10, or an information storage medium. In this case, the function information acquisition module 102 may acquire the link information from the another database, the another computer other than the server 10, or the information storage medium.

The explanatory information generation module 103 in Modification Example 5 causes the AI to generate the explanatory information based on the link information. The default prompt in Modification Example 5 indicates that the AI is to generate explanatory information based on the link information. For example, the default prompt indicates a sentence such as "You are an AI that generates explanatory information for an app. The link information input to you is information indicating a link to another app from this app. This app and the another app have a relevance to each other, so please generate appropriate explanatory information as an explanation for the app based on the relevance." Information on the another app (for example, setting information such as the app name of the another app) the app is linked to, which is indicated by the link information, may be embedded in the default prompt. Through embedding such information in the default prompt, the AI can recognize the relevance between the apps in more detail.

For example, in Modification Example 5, the AI is managed by an external system, and hence the explanatory information generation module 103 inputs the default prompt and the link information to the AI by transmitting the default prompt and the link information to the external system. When the external system receives the default prompt and the link information, the external system inputs the default prompt and the link information to the AI. Additional default prompts may be prepared on the external system side.

For example, the AI calculates an embedded representation of the default prompt and the link information based on parameters adjusted by pre-training. The AI outputs the app explanatory information corresponding to the embedded representation. The AI may divide the default prompt and the link information into units called tokens, and calculate an embedded representation of each token. The AI outputs the explanatory information of the app after predicting the next sentence as required based on a sequence of the embedded representations of the tokens.

For example, the link information indicates a link to another app having a relevance to the app for which explanatory information is to be generated. The AI recognizes the relevance between those apps, and outputs explanatory information corresponding to the relevance of the apps. The AI recognizes the explanatory information that is to be output by the AI based on the embedded representation of the default prompt. The AI may output not only the explanatory information of the app, but also an answer message to the user. The fact that the AI is to output an answer message may be indicated in the default prompt. The flow in which the explanatory information generation module 103 acquires the output of the AI from the external system and the explanatory information providing module 104 provides the explanatory information may be the same as in the at least one embodiment and Modification Examples 1 to 4. The point that a default prompt is not particularly required to be input to the AI may also be the same as in Modification Examples 1 to 4.

The work support system 1 according to Modification Example 5 acquires the link information relating to the link to the another work support function associated with the work support function as the function information. The work support system 1 causes the AI to generate the explanatory information based on the link information. The link information may be useful in estimating the relevance of the work support function, and hence the work support system 1 can increase the accuracy of the explanatory information by causing the AI to generate the explanatory information based on the link information.

### 6-6. Modification Example 6

For example, the user may make a post including content relating to a specific work support function to the work support system 1. In the case of the meeting minutes management app described in the at least one embodiment, the user may mention another user and make a post such as "I have registered the meeting minutes of the meeting in the meeting minutes management app. Please check the meeting minutes." The content of such a post may be useful as an explanation of the work support function, such as the app as an example. Thus, in Modification Example 6, a case in which posted information is acquired as the function information is taken as an example.

The function information acquisition module 102 in Modification Example 6 acquires, as the function information, posted information relating to a post made in the work support system 1 that includes content relating to the work support function. The posted information is included as the actual data of the work support function. For example, when an app corresponds to the work support function, the function information acquisition module 102 acquires posted information indicating a comment on the app. The posted information may indicate a post made in another place, such as a thread, instead of a comment on the app. The data of the post made in the another place is assumed to be stored in the data storage unit 100.

The posted information may be stored in another database other than the work support database DB, another computer other than the server 10, or an information storage medium. In this case, the function information acquisition module 102 may acquire the posted information from the another database, the another computer other than the server 10, or the information storage medium. The function information acquisition module 102 may acquire the posted information of a post that includes a link to or the name of an app for which explanatory information is to be generated. That is, the function information acquisition module 102 may acquire the posted information of a post including a character string that can identify an app, such as an app name, as posted information including content relating to the app. The function information acquisition module 102 may acquire the posted information of a post including a link to an app for which explanatory information is to be generated, as posted information including content relating to the app.

The explanatory information generation module 103 in Modification Example 6 causes the AI to generate explanatory information based on the posted information. The default prompt in Modification Example 6 indicates that the AI is to generate explanatory information based on the posted information. For example, the default prompt indicates a sentence such as "You are an AI that generates explanatory information for an app. The posted information input to you includes content relating to this app, so please generate appropriate explanatory information as an explanation for the app based on the posted information."

For example, in Modification Example 6, the AI is managed by an external system, and hence the explanatory information generation module 103 inputs the default prompt and the posted information to the AI by transmitting the default prompt and the posted information to the external system. When the external system receives the default prompt and the posted information, the external system inputs the default prompt and the posted information to the AI. Additional default prompts may be prepared on the external system side.

For example, the AI calculates an embedded representation of the default prompt and the posted information based on parameters adjusted by pre-training. The AI outputs the app explanatory information corresponding to the embedded representation. The AI may divide the default prompt and the posted information into units called tokens, and calculate an embedded representation of each token. The AI outputs the explanatory information of the app after predicting the next sentence as required based on a sequence of the embedded representations of the tokens.

For example, the posted information indicates content relating to the app. The AI recognizes the purpose, for example, of the app based on the content of the post indicated by the posted information, and outputs explanatory information corresponding to the recognition result. The AI recognizes the explanatory information that is to be output by the AI based on the embedded representation of the default prompt. The AI may output not only the explanatory information of the app, but also an answer message to the user. The fact that the AI is to output an answer message may be indicated in the default prompt. The flow in which the explanatory information generation module 103 acquires the output of the AI from the external system and the explanatory information providing module 104 provides the explanatory information may be the same as in the at least one embodiment and Modification Examples 1 to 5. The point that a default prompt is not particularly required to be input to the AI may also be the same as in Modification Examples 1 to 5.

The work support system 1 according to Modification Example 6 acquires the posted information relating to a post made in the work support system 1 that includes content relating to the work support function as the function information. The work support system 1 causes the AI to generate the explanatory information based on the posted information. The posted information may include content which is useful in explaining the work support function, and hence the work support system 1 can increase the accuracy of the explanatory information by causing the AI to generate the explanatory information based on the posted information.

### 6-7. Modification Example 7

For example, the user may be able to designate the data format of the explanatory information. In Modification Example 7, when the user instructs explanatory information to be generated from the app content screen SC2, the user is able to designate the data format of the explanatory information. On the app content screen SC2, the user can designate any data format from among a plurality of data formats. The plurality of data formats are assumed to be determined in advance. Data indicating the plurality of data formats is stored in the data storage unit 100. A program for converting the explanatory information generated by the AI into each of the plurality of data formats is also assumed to be stored in the data storage unit 100.

The work support system 1 according to Modification Example 7 includes the data format reception module 105. The data format reception module 105 receives a designation of the data format for the explanatory information. The data format that the user can designate may be any data format. For example, the data format may be a text format, a rich text format, a document file format, a markup language format such as HTML, an image format, or another format. For example, when the user designates the data format, the user terminal 20 transmits data indicating the data format designated by the user to the server 10. The data format reception module 105 receives the designation of the data format by receiving the transmitted data.

The explanatory information providing module 104 in Modification Example 7 converts the explanatory information based on the data format received by the data format reception module 105, and provides the converted explanatory information. The explanatory information providing module 104 converts the explanatory information generated by the AI into the data format designated by the user based on a program for converting the explanatory information. The explanatory information providing module 104 stores the converted explanatory information in the work support database DB. Modification Example 7 is different from the at least one embodiment in the point that the explanatory information providing module 104 executes data format conversion, but the processing for providing the explanatory information may be the same as in the at least one embodiment.

The work support system 1 according to Modification Example 7 receives the designation of the data format relating to the explanatory information. The work support system 1 converts the explanatory information based on the data format, and provides the converted explanatory information. As a result, the user can acquire the explanatory information in a desired data format, and hence the work support system 1 can increase the convenience of the user.

### 6-8. Modification Example 8

For example, the explanatory information generation module 103 may cause the AI to generate explanatory information including a plurality of explanations and a priority of each of the plurality of explanations. The priority can also be said to be an accuracy of an estimation by the AI. The AI may be able to calculate a score indicating the accuracy of the estimation of each generated output by the AI. Such a score may be called a confidence or a probability. The AI may calculate the score as the priority. Any one of various publicly-known calculation methods may be used to calculate the score. For example, when the AI calculates a confidence regarding the selection of a word when predicting the next word, the confidence level may be used as the priority.

The default prompt in Modification Example 8 indicates that when a plurality of explanations are included in the explanatory information, a priority is given to each explanation. For example, the default prompt includes a sentence such as "When there are a plurality of explanations, please give a priority to each explanation" in addition to the wording described in the at least one embodiment. The AI calculates and outputs the priority of each explanation included in the explanatory information based on the default prompt. The explanatory information generation module 103 stores the priority of each of the plurality of explanations in the work support database DB.

The explanatory information providing module 104 in Modification Example 8 provides the explanatory information based on the priority of each of the plurality of explanations. For example, the explanatory information providing module 104 provides only the explanations having a priority equal to or higher than a threshold value among the plurality of explanations. The explanatory information providing module 104 provides only a predetermined number of explanations among the plurality of explanations in descending order of priority. Modification Example 8 is different from the at least one embodiment in the point that the explanatory information providing module 104 uses the priority to determine whether or not to provide the plurality of explanations indicated by the explanatory information, but the processing itself for providing each explanation may be the same as in the at least one embodiment.

The work support system 1 according to Modification Example 8 causes the AI to generate explanatory information including a plurality of explanations and the priority of each of the plurality of explanations. The work support system 1 provides the explanatory information based on the priority of each of the plurality of explanations. As a result, the user can know the explanation having a high priority, and hence the work support system 1 can increase the convenience of the user.

### 6-9. Other Modification Examples

For example, two or more of Modification Examples 1 to 8 may be combined.

For example, the functions described as being implemented by the server 10 may be implemented by another computer. The functions described as being implemented by the server 10 may be distributed to a plurality of computers.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A work support system, comprising at least one processor configured to:
acquire function information relating to a work support function that supports work;
cause an artificial intelligence (AI) to generate explanatory information relating to an explanation of the work support function based on the function information; and
provide the explanatory information.

2. The work support system according to claim 1, wherein the at least one processor is configured to:
cause the AI or another AI to generate the work support function based on a user input prompt input by a user, the user input prompt relating to specific content of the work support function;
acquire the user input prompt as the function information; and
cause the AI to generate the explanatory information based on the user input prompt.

3. The work support system according to claim 1, wherein the at least one processor is configured to:
acquire setting information relating to a setting of the work support function as the function information; and
cause the AI to generate the explanatory information based on the setting information.

4. The work support system according to claim 3, wherein the at least one processor is configured to:
acquire a program code for extending the work support function as the setting information; and
cause the AI to generate the explanatory information based on the program code.

5. The work support system according to claim 1,
wherein the work support function is a database function that supports the work by using a database, and
wherein the at least one processor is configured to:
acquire record information relating to a record in the database as the function information; and
cause the AI to generate the explanatory information based on the record information.

6. The work support system according to claim 1, wherein the at least one processor is configured to:
acquire user information relating to a user who has generated or created the work support function as the function information; and
cause the AI to generate the explanatory information based on the user information.

7. The work support system according to claim 1, wherein the at least one processor is configured to:
acquire link information relating to a link to another work support function associated with the work support function as the function information; and
cause the AI to generate the explanatory information based on the link information.

8. The work support system according to claim 1, wherein the at least one processor is configured to:
acquire, as the function information, posted information relating to a post made in the work support system, the post including content relating to the work support function; and
cause the AI to generate the explanatory information based on the posted information.

9. The work support system according to claim 1, wherein the at least one processor is configured to:
receive a designation of a data format relating to the explanatory information; and
convert the explanatory information based on the data format, and provide the converted explanatory information.

10. The work support system according to claim 1, wherein the at least one processor is configured to:
cause the AI to generate explanatory information including a plurality of explanations and a priority of each of the plurality of explanations; and
provide the explanatory information based on the priority of each of the plurality of explanations.

11. A work support method, comprising:
acquiring function information relating to a work support function that supports work;
causing an artificial intelligence (AI) to generate explanatory information relating to an explanation of the work support function based on the function information; and
providing the explanatory information.

12. A non-transitory information storage medium having stored thereon a program for causing a computer to:
acquire function information relating to a work support function that supports work;
cause an artificial intelligence (AI) to generate explanatory information relating to an explanation of the work support function based on the function information; and
provide the explanatory information.
